(19) United States
(12) Patent Application Publication
(10) Pub. No.: US 2009/0210493 A1
(43) Pub. Date: Aug. 20, 2009

(54) Communicating and Displaying Hyperlinks in a Computing Community

(75) Inventors: Jerry A. Johnson, Medina, WA (US); Jeffrey S. Stone, Bellevue, WA (US); Christian R. Lehew, Redmond, WA (US); Michael R. Courage, Kirkland, WA (US); Brendan K. Reville, Seattle, WA (US); Linus Lee, Bellevue, WA (US); Chandler J. Holbrook, Lynnwood, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/032,507

(22) Filed: Feb. 15, 2008

(51) Int. Cl. G06F 15/16

(52) U.S. Cl. 709/205

(57) ABSTRACT

Various aspects are disclosed herein for communicating and displaying of hyperlinks in a computing community. Hyperlinks can be communicated by being embedded in messages, such that users of a closed computing community can send and receive such hyperlinks. These hyperlinks can link to hyperlinked content that can be stored on a central computing device responsible for administering the community. Moreover, any content that is associated with hyperlinks, whether that content is in the form of blogs, RSS feeds, and so on, can be made publicly available while any associated hyperlinks will be visible only to a subset of computing devices, namely, the community computing devices (but not to any general computing devices accessing the content). This task may be accomplished by using predetermined and/or proprietary schema properly understood only by the community computing devices.

### COPYRIGHT NOTICE AND PERMISSION

A portion of the disclosure of this document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2008 Microsoft Corp.

### FIELD OF TECHNOLOGY

The presently disclosed subject matter relates to the field of computing, and more particularly, to fields such as media content, although this is merely an exemplary and non-limiting field.

### BACKGROUND

Game console users of online gaming systems may want to communicate with other users in their gaming community. Such communication may entail telling other users about new games coming out, special outstanding offers, or interesting available content, such as blogs, RSS feeds, podcasts, and so on. However, presently game console users have no easy way of accomplishing this task. A game online system that allows only for text communication, for example, does not solve the need for rich communication among a community of game console users.

### SUMMARY OF THE INVENTION

Various aspects are disclosed herein for communicating and displaying of hyperlinks in a computing community. Hyperlinks can be communicated by being embedded in messages, such that users of a closed computing community can send and receive such hyperlinks. These hyperlinks can link to hyperlinked content that can be stored on a central computing device responsible for administering the community.

In one aspect of the presently disclosed subject matter, any content that is associated with hyperlinks, whether that content is in the form of blogs, RSS feeds, and so on, can be made publicly available while any associated hyperlinks will be visible only to a subset of computing devices, namely, the community computing devices (but not to any general computing devices accessing the content). This task may be accomplished by using predetermined and/or proprietary schema properly understood only by the community computing devices.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are illustrated. However, the disclosure is not limited to the specific aspects shown. The following figures are included:

FIG. 1 illustrates various game consoles communicating content notifications among each other;

FIG. 2 illustrates service computing devices and/or content publishers/partners providing the content notifications discussed with respect to FIG. 1;

FIG. 3 illustrates that content notifications embodied as messages with embedded hyperlinks can be sent and/or received among various computing devices, such as game consoles, personal computers, and/or handhelds, and that these messages can also be sent and/or received to/from service providers and/or content publishers/partners;

FIG. 4 illustrates that hyperlinks otherwise publicly available to various computing devices may be visible only to a subset of such computing devices (and therefore invisible to the rest);

FIG. 5 illustrates the difference between accessibility to content between different types of computing devices;

FIG. 6 illustrates the sending of a plurality of messages with embedded hyperlinks and how such messages are related to the underlying content (such as blogs, RSS feeds, and the hyperlinked content);

FIG. 7 illustrates a block diagrams depicting both server-side and client-side aspects of the presently disclosed subject matter;

FIG. 8 illustrates in block diagram form an exemplary multimedia console that can be used in conjunction with the various aspects of a hyperlinking system discussed with reference to FIGS. 1-7 and 9; and

FIG. 9 illustrates an exemplary networking environment for subject matter discussed with reference to FIGS. 1-8.

### DETAILED DESCRIPTION OF ILLUSTRATIVE EMBODIMENTS

### Aspects of Communicating and Exposing Hyperlinks in a Computing Community

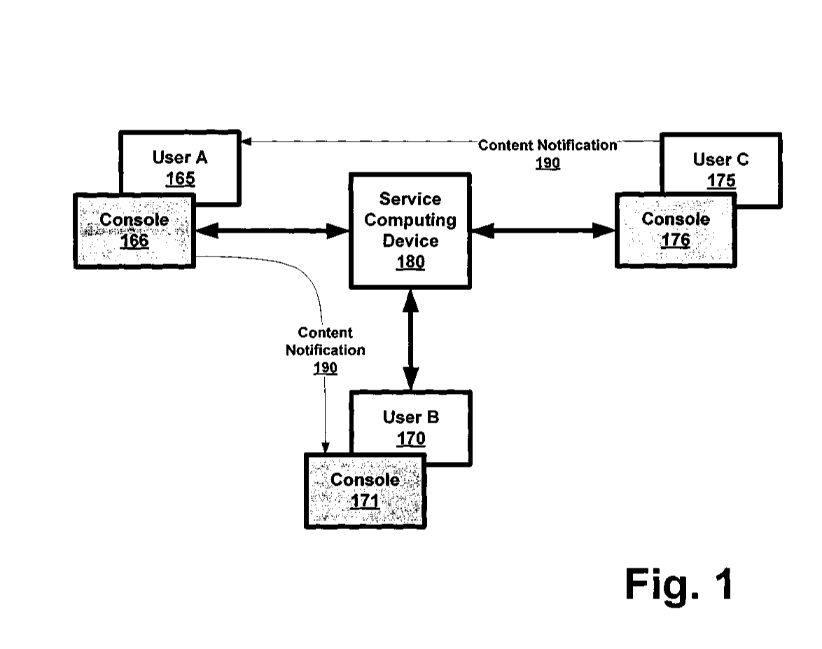

In one aspect of the presently disclosed subject matter, FIG. 1 illustrates a plurality of computing devices, such as game consoles 166, 171, 176 connected to a service computing device 180 that is configured to provide access and content to these game consoles 166, 171, 176. These computing devices 166, 171, 176 can communicate with each other, whether during game play or not. By way of example, content notifications 190 can be send from user A 165 on a first console 166, to a user B 170 on a second console 171. Or, alternatively, user C 175 may send content notifications 190 to user A 165. Thus, any user can both send and receive such content notifications 190.

“Content” herein is used to denote any code and/or data that can be sent among the community of users 165, 170, 175 shown in FIG. 1. By way of example, content may include text, pictures, video, and/or audio. These users 165, 170, 175 may want to share information about certain games, or about interesting content on blogs, or web sites. Shown in FIG. 1 is the service computing device 180 that mediates interactions between the various consoles 166, 171, 176. This, however, is merely an exemplary architecture, since these consoles and any computing devices discussed herein could communicate in a peer-to-peer network (instead of the shown client-server setup).

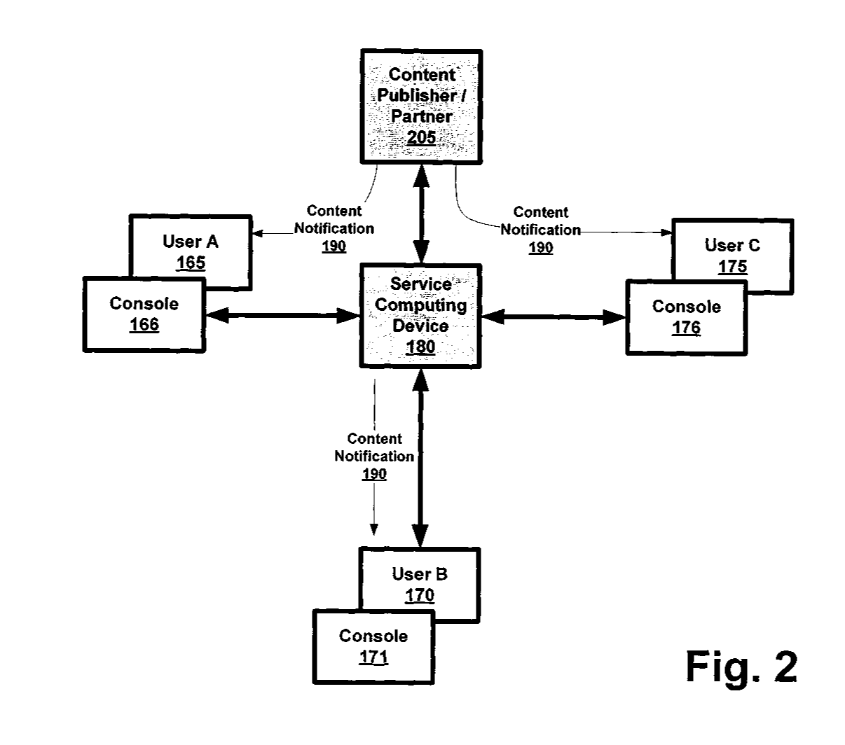

FIG. 2 builds on FIG. 1 and illustrates that content notifications 190 can also be sent from the service computing device 180 or content publishers and various other partners 205. These content notifications 190 may include promotions or advertisements for new games that the service computing device 180 or the publisher 205 has made available. These content notifications 190 can be sent to a targeted set of users or they may be sent to all users in communication with the service computing device 180. Users 165, 170, 175 can sign up for these notifications and they in turn may appear on the menu of the corresponding consoles 166, 171, 176.

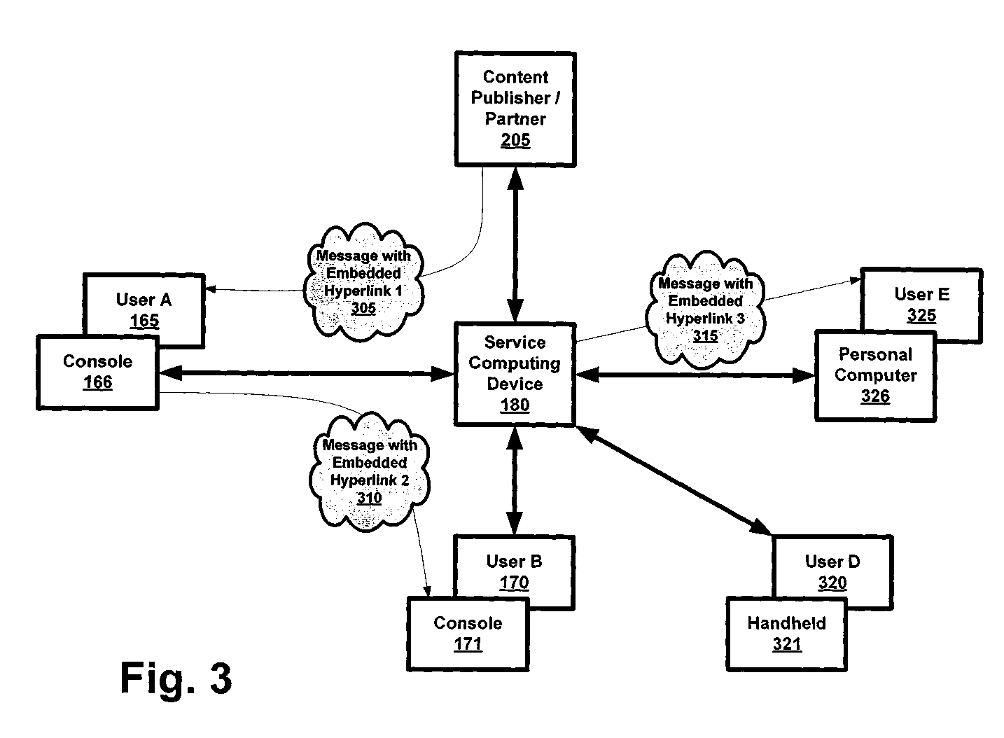

The above discussed content notifications 190 may be embodied as various types of messages that have in them embedded hyperlinks. FIG. 3 illustrates that messages with embedded hyperlinks 305, 310, 315 can be sent among computing devices in a community of such devices, be they game consoles 166, 171, personal computers 326, handheld devices 321, and so on. Moreover, these messages 305, 310, 315 can be sent from the service computing device 180 and/or other partners 205 (such as content publishers) to the community of computing devices 166, 171, 321, 326. And, likewise, the service computing device 180 and/or other partners 205 can receive various messages with embedded hyperlinks from the users 165, 170, 320, 325.

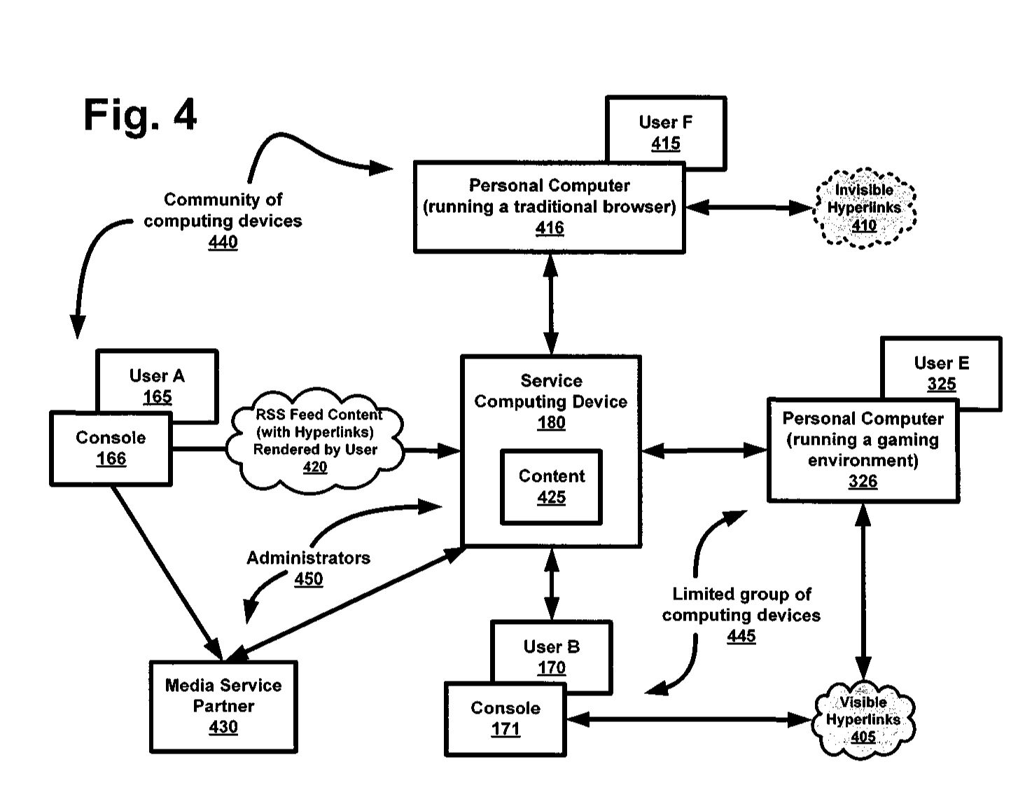

FIG. 4 illustrates that content otherwise publicly available to various computing devices may contain hyperlinks visible only to a subset of such computing devices (and therefore invisible to the rest). In FIG. 4, in one exemplary scenario, user A 165 associated with console A 166 may publish really simple syndication (RSS) content with embedded hyperlinks 420 that link to other pages stored on the service computing device 180. Once such content 425 is uploaded and stored on the service computing device 180, it can be accessed by other computing devices, such as other consoles 171, personal computers running gaming environments 326, or just plain personal computers running traditional browsers 416.

However, any hyperlinks that are part of such content or associated with such content can be visible 405 only to consoles 166, 171 and personal computers 326 running closed computing environments 445. A closed system can be limited to either devices of a specified type or to devices running specialized software; for example, contemplated herein are at least gaming consoles, cellular phones, personal digital assistants, personal computers with a specialized software, and so on.. Thus, personal computers running traditional browsers 416 will not be able to see such hyperlinks 410 even though they may be able to see the rest of the content 425 (such as text, pictures, and so on). One way in which the limited visibility of hyperlinks is made possible is through a predetermined and/or proprietary schema that closed systems can interpret in the intended manner. In other words, hyperlinks can be visible only to the aforementioned devices 166, 171, 326 because these devices can read a schema that exposes these hyperlinks (whereas a traditional browser may be able to read the rest of the content, and yet not see the hyperlinks). The schema may be implemented in various markup languages, such as XML.

It should be noted that RSS feeds can be supplied by servers dedicated to the closed system devices (publishing using the aforementioned schema), or they may include generally published RSS feeds that include the aforementioned schema. Moreover, a plurality of RSS feeds from different and disparate sources may be consumed by the devices shown in FIG. 4.

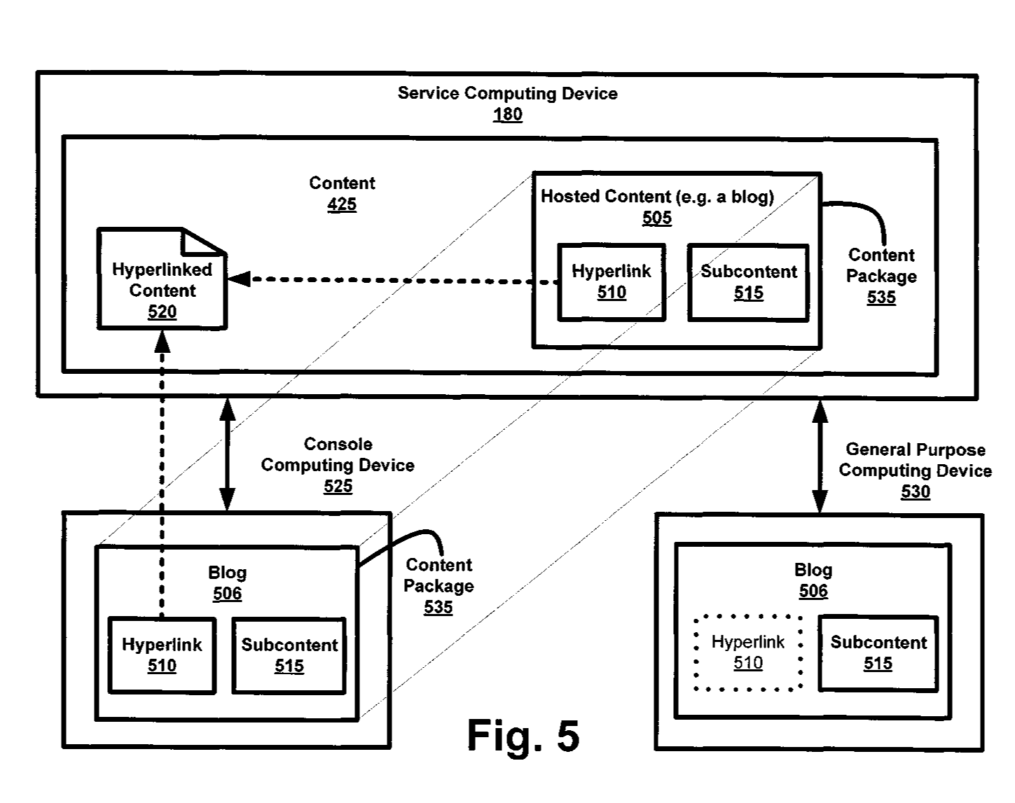

In another aspect of the presently disclosed subject matter, FIG. 5 illustrates the difference between accessibility to content is shown between different types of computing devices. A console computing device 525 is shown alongside a general purpose computing device 530. Each of these devices 525, 530 can access a service computing device 180, which may be a centralized or a distributed device. On the console computing device 525, a blog 506 may be seen with some subcontent 515 (such as text, pictures, audio, video, and so on), and an associated hyperlink 510. The subcontent 515 may describe a new game that is coming up, and the hyperlink 510 may link to the game, where the game can be stored on the service computing device as hyperlinked content 520. Alternatively, the hyperlinked content 520 may reside on other consoles and personal computers, and the service computing device 180 may serve as an intermediary between other computing devices (or not, if a pure peer-to-peer network is established).

The subcontent 515 and the hyperlink 510 can reside on the service computing device 180 as hosted content 505 that is accessible to other computing devices, such a general purpose computing device 530. Such hosted content 505 may be part of a content package 535, and such content package 535 may include together with the hyperlinked content 520 the overall discussed content 425. Of course, such content 425 may include other code and/or data, and the discussion herein of content is merely exemplary and non-limiting.

If the general purpose computing device 530 access the content package 535, it may also have access to the subcontent 515, but any hyperlinks 510 that appear on the console computing device 525 will not appear on the general purpose computing device 530 (as is shown with the dashed line of hyperlinks 510 on the general purpose computing device 530). Of course, the notion of limited visibility of content to a subset of computing devices is not limited to hyperlinks, but may include any of the other disclosed types of content.

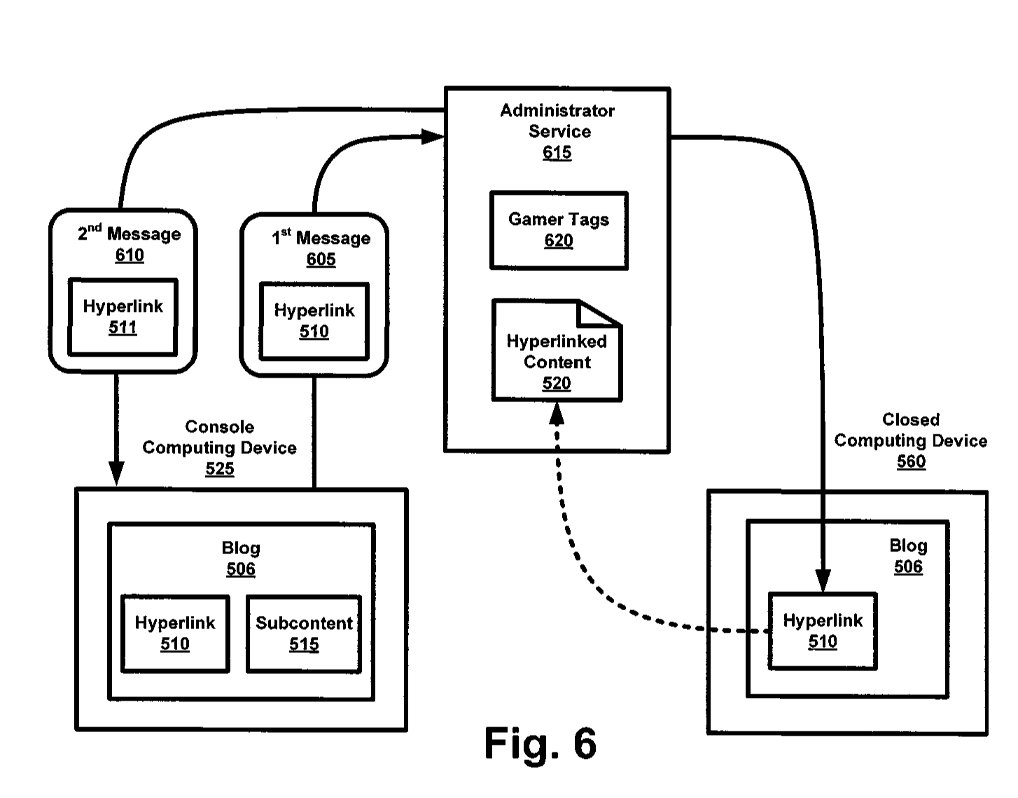

In another aspect of the presently disclosed subject matter, FIG. 6 illustrates that various types of messages can be sent among computing devices. In order to make content readily accessible to users, such content can be hyperlinked 520, and a message can be sent having embedded hyperlinks 510 to such hyperlinked content 520. By way of example, the console computing device 525 of FIG. 5 can send a first message 605 to another closed computing device 560. This message can include text, video, audio, and so on, perhaps describing the hyperlinked content 520. A user of the closed computing device 560 can receive the hyperlink 510 and then access the hyperlinked content 520.

Similarly to sending messages with embedded hyperlinks, such messages can also be received by the console computing device 525, be they received from other computing devices 560 or some administrative service 615. In the latter scenario, a central content broker or some associated partner can send messages to selected consoles, such as the shown console 525, letting them know of interesting content. Along with the received message, an accompanying hyperlink may be provided.

In one aspect of the present disclosure, the hyperlink 510 can be displayed as the normal interface component of the console computing device 525. Thus, while in one implementation it may be a traditional hyperlink, in another it may appear on a menu as a selection field or button that is visually integrated into the console 525 display menu. Put in other words, what the present disclosure contemplates is giving users the ability to import and export not only hyperlinked functionality from other users, but also the look and feel associated with such functionality (be it radial buttons, selection fields, pictures, and so on).

Another way in which users can access the hyperlinked content 520 is not by passively receiving messages, but by actively searching for such content by examining the gamer tags 620 of other users. By way of example, a gamer tag (not shown) may be associated with a user of the console computing device 525. The user of the closed computing device 560 can search any blogs, podcasts, or just about any publications by the user of the console 525 via that user's gamer tag, and then follow hyperlinked content via the aforementioned hyperlinks. Of course, gamer tags are only one exemplary way in which users can access hyperlinked content, other may include user groups, friend's lists, and so on.

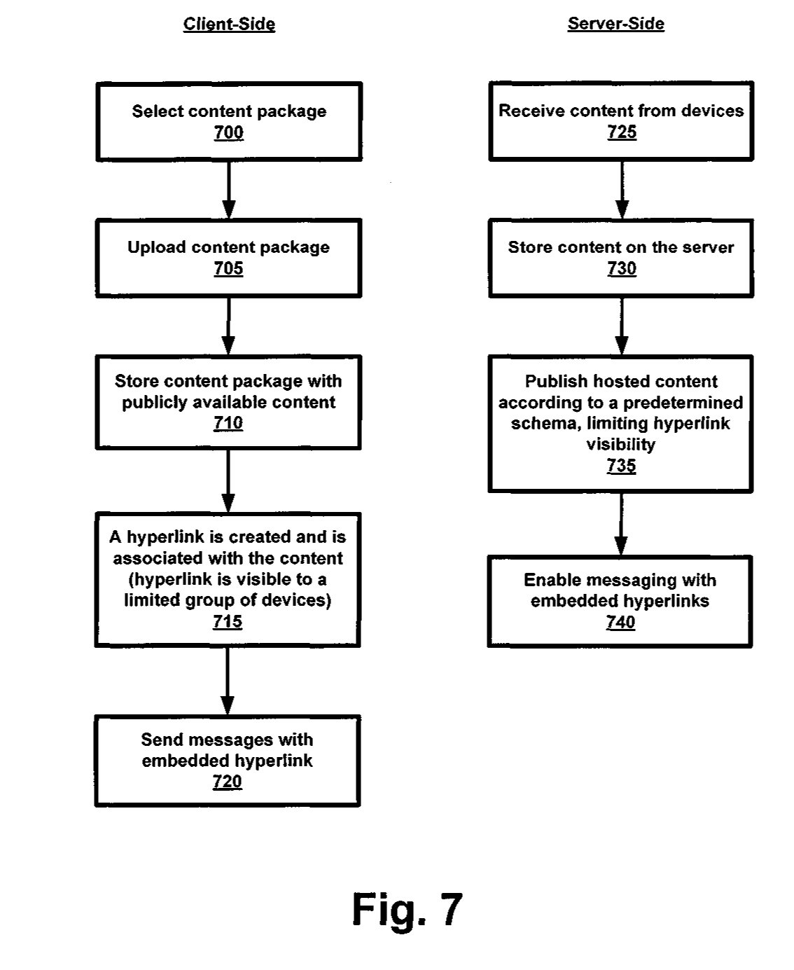

Finally FIG. 7 illustrates a block diagram of exemplary and non-limiting methods for creating, sending, and displaying hyperlinks among a plurality of computing devices, including client and server computing devices. These methods can be performed both by client side users and server side administrators (among other users). Thus, from the client-side point of view, at block 700, a content package is selected to be published to a community of computing device users. Then, at block 705, the content package is uploaded to a server computing device. Once the content package is uploaded, at block 710 it can be stored on the server computing device, where the content package can be publicly available to the community of device users.

At block 715, a hyperlink can be created as part of the content package, where a hyperlinked content can be accessible via the hyperlink by a community of computing devices. Moreover, the hyperlink can be visible to a limited group of computing devices in the community of computing devices. Once this is set up, at block 720, a first message can be sent from a first computing device of the community of computing devices to another at least one computing device of the community of computing devices, where the first message can have an embedded hyperlink. It is contemplated herein that messages may also not only be sent, but also received, and not just from other computing devices in the community of devices, but also administrative or centralized computing devices.

On the server-side, a computer readable medium can be used to store thereon computer executable instructions for at least allowing a plurality of users to send hyperlinks to a community of gaming computing device users and for allowing administrators to send and display hyperlinks to the community of gaming computing device users. It should be noted however, that such computer readable media can be used both on the server-side as well as the client-side (as is also true for the above processes), thus the following and preceding discussion is merely exemplary and thus non-limiting. At block 725, at least one instruction can be used that receives content from a closed computing device from a set of computing devices, including other closed computing devices and general purpose computing devices, wherein the content is a hosted content on a service computing device. Then, at block 730, at least one instruction can store the hosted content on the service computing device, where the service computing device is configured to interact with the set of computing devices as a server computing device or a peer computing device.

Next, at block 735, at least one instruction can publish the hosted content to the set of computing devices according to a predetermined schema, resulting in any hyperlinks associated with the hosted content to be visible only to the closed computing devices and being invisible to the general purpose computing devices. Following this, at block 740, at least one instruction can receive and forward a message with an embedded hyperlink out of the aforementioned hyperlinks to at least one closed computing device, thereby allowing for the sharing of such hyperlinks.

The aspects discussed with respect to FIG. 7 can be implemented with the various aspects discussed above and below. For example, client computing devices from a plurality of client computing devices can be mobile computing device or a stationary computing device. The aforementioned hyperlinks can be associated with banner advertisements. And, the hyperlink can be embedded in voice mails, text mails, podcasts, videos, and so on, as is disclosed throughout the specification. Thus, any portion of this disclosure can interface and be implemented with any other portion thereof.

### Exemplary Computing Devices and Networks For Hyperlinking Activity in a Computing Community

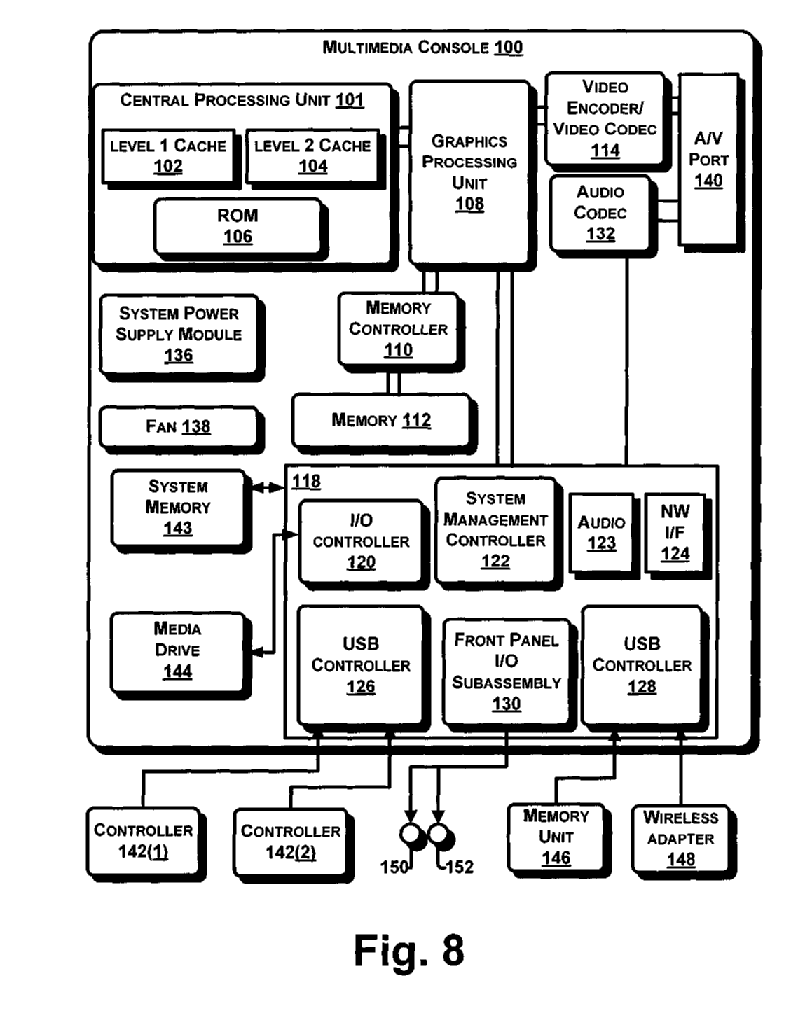

The above discussed computing devices 166, 171, 321, 326, whether native or remote, can be embodied as gaming consoles, music players, PCs, and other such devices having different, similar, or the same platforms. Contemplated herein are also hand-held devices, laptops, cell phones, and so on. Referring to FIG. 8, a block diagram shows an exemplary multimedia console that can be used in conjunction with the various aspects of the hyperlinking system discussed above. This console, which includes a game oriented console or a PC, may comprise, for example, digital audio processing functionality. Specifically, in FIG. 8, a multimedia console 100 is shown, with a central processing unit (CPU) 101 having a level 1 (L1) cache 102, a level 2 (L2) cache 104, and a flash ROM (Read-only Memory) 106. The level 1 cache 102 and level 2 cache 104 can temporarily store data and hence reduce the number of memory access cycles, thereby improving processing speed and throughput. The flash ROM 106 may store executable code that is loaded during an initial phase of a boot process when the multimedia console 100 is powered. Alternatively, the executable code that is loaded during the initial boot phase can be stored in a flash memory device (not shown). Further, ROM 106 can be located separately from the CPU 101. These memory devices can cache parts or the entirety of the above mentioned applications, programs, applets, managed code, and so on.

A graphics processing unit (GPU) 108 and a video encoder/video codec (coder/decoder) 114 can form a video processing pipeline for high speed and high resolution graphics processing. Data can be carried from the graphics processing unit 108 to the video encoder/video codec 114 via a bus. The video processing pipeline can output data to an A/V (audio/video) port 140 for transmission to a television or other display. A memory controller 110 can be connected to the GPU 108 and CPU 101 to facilitate processor access to various types of memory 112, such as, but not limited to, a RAM (Random Access Memory).

The multimedia console 100 can include an I/O controller 120, a system management controller 122, an audio processing unit 123, a network interface controller 124, a first USB host controller 126, a second USB controller 128 and a front panel I/O subassembly 130 that can be preferably implemented on a module 118. The USB controllers 126 and 128 can serve as hosts for peripheral controllers 142(1)-142(2), a wireless adapter 148, and an external memory unit 146 (e.g., flash memory, external CD/DVD ROM drive, removable media, etc.). Thus, hyperlinks may be created and sent using these controllers 142(1)-142(2) or any other suitable input means. Moreover, the network interface 124 and/or wireless adapter 148 can provide access to a network (e.g., the Internet, home network, etc.) and may be any of a wide variety of various wired or wireless interface components including an Ethernet card, a modem, a Bluetooth module, a cable modem, and the like.

System memory 143 can be provided to store application data that is loaded during the boot process. A media drive 144 can be provided and can comprise a DVD/CD drive, hard drive, or other removable media drive, etc. The media drive 144 can be internal or external to the multimedia console 100. Application data can be accessed via the media drive 144 for execution, playback, etc. by the multimedia console 100. The media drive 144 can be connected to the I/O controller 120 via a bus, such as a Serial ATA bus or other high speed connection (e.g., IEEE 1394).

The system management controller 122 can provide a variety of service functions to assure the availability of the multimedia console 100. The audio processing unit 123 and an audio codec 132 can form a corresponding audio processing pipeline with high fidelity, 3D, surround, and stereo audio processing according to aspects of the presently disclosed subject matter above. Audio data can be carried between the audio processing unit 123 and the audio codec 126 via a communication link. The audio processing pipeline can output data to the A/V port 140 for reproduction by an external audio player or device having audio capabilities.

The front panel I/O subassembly 130 can support the functionality of the power button 150 and the eject button 152, as well as any LEDs (light emitting diodes) or other indicators exposed on the outer surface of the multimedia console 100. A system power supply module 136 can provide power to the components of the multimedia console 100. A fan 138 can cool the circuitry within the multimedia console 100.

The CPU 101, GPU 108, memory controller 110, and various other components within the multimedia console 100 can be interconnected via one or more buses, including serial and parallel buses, a memory bus, a peripheral bus, and a processor or local bus using any of a variety of bus architectures.

When the multimedia console 100 is powered on or rebooted, application data can be loaded from the system memory 143 into memory 112 and/or caches 102, 104 and executed on the CPU 101. Such application data can include some of the online derived data. The application may also present a graphical user interface that provides a consistent user experience when navigating to different media types available on the multimedia console 100. In operation, applications and/or other media contained within the media drive 144 can be launched or played from the media drive 144 to provide additional functionalities to the multimedia console 100.

The multimedia console 100 may be operated as a standalone system by simply connecting the system to a television or other display. In this standalone mode, the multimedia console 100 may allow one or more users to interact with the system, watch movies, listen to music, and the like. However, with the integration of broadband connectivity made available through the network interface 124 or the wireless adapter 148, the multimedia console 100 may further be operated as a participant in a larger network community of computing devices, such as devices 166, 171, 176, 205, 326, 416 and so on. As such a participant, it may interact with computing devices, whether PCs or servers, and receive information that may be eventually stored.

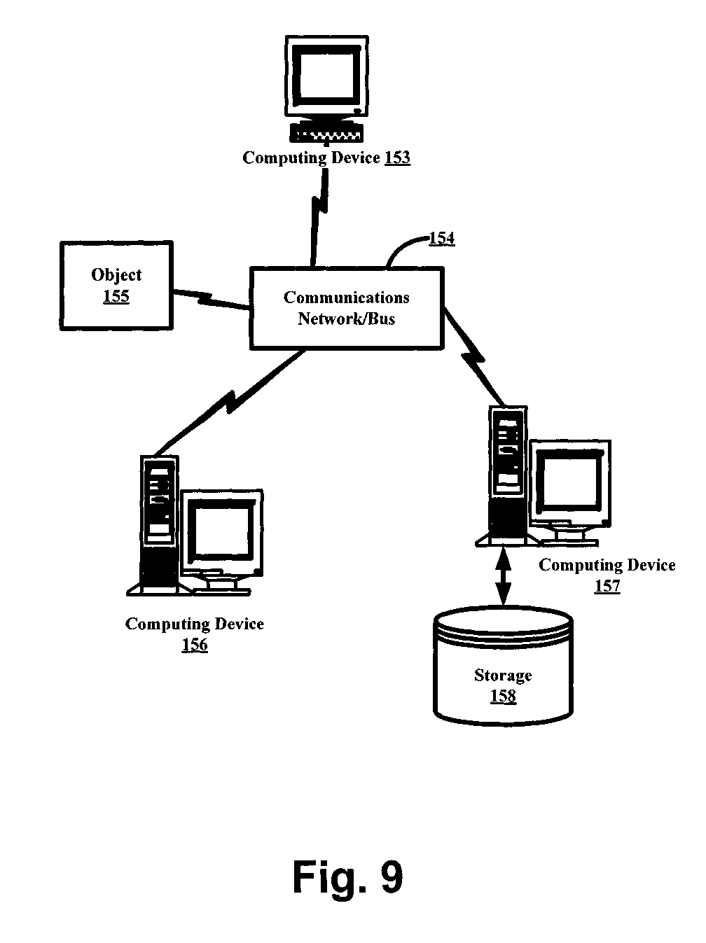

Next, FIG. 9 illustrates an exemplary networking environment for subject matter discussed with reference to FIGS. 1-8. The above discussed gaming console 100 can correspond to any one of the computing devices 153, 156, 157, or it can be distributed over such devices 153, 156, 157. It can interact with various other objects 155 and storage devices 158 via a communications network/bus 154, where such objects and devices can correspond to other computing devices (whether hardware, firmware, or software). The cross-platform applications can communicate in peer-to-peer networks or client-server based networks, depending on the implementation. Thus, for example, the service computing device 180 may be in a server-client relationship with a console 166, or the service computing device 180 may be in a peer-to-peer relationship with console 171.

Finally, it should also be noted that the various techniques described herein may be implemented in connection with hardware or software or, where appropriate, with a combination of both. Thus, the methods and apparatus of the presently disclosed subject matter, or certain aspects or portions thereof, can take the form of program code (i.e., instructions) embodied in tangible storage media, such as floppy diskettes, CD-ROMs, hard drives, or any other machine-readable storage medium, where, when the program code is loaded into and executed by a machine, such as a computer, the machine becomes an apparatus for practicing the subject matter.

In the case of program code execution on programmable computers, the computing device may generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing application programming interface (API) or the like, are preferably implemented in a high level procedural or object oriented programming language to communicate with a computer system. However, the program(s) can be implemented in assembly or machine language, if desired. In any case, the language may be a compiled or interpreted language, and combined.

Finally, while the present disclosure has been described in connection with a plurality of exemplary aspects, as illustrated in the various figures and discussed above, it is understood that other similar aspects may be used or modifications and additions may be made to the described aspects for performing the same function of the present disclosure without deviating therefrom. For example, in various aspects of the disclosure, methods, systems, and computer readable media were described configured for hyperlinking and communicating content in a community of computing devices. However, other equivalent mechanisms to these described aspects are also contemplated by the teachings herein. Therefore, the present disclosure should not be limited to any single aspect, but rather construed in breadth and scope in accordance with the appended claims.

What is claimed:

1. A system for hyperlinking content and communicating hyperlinks among client computing devices and service computing devices, comprising:
a service computing device configured to host content accessible by a plurality of client computing devices;
said content residing on said media computing device, and comprising hyperlinked content and hosted content;
said service computing device is configured to publish said content to said plurality of client computing devices;
wherein a hyperlink to said hyperlinked content is configured to be sent in a message from at least one client computing device of said plurality of client computing devices to another at least one client computing device of said plurality of client computing devices, or to be sent in a message from an administrator to at least one client computing device of said plurality of client computing devices; and
wherein said hyperlink is visible only to a subset of client computing devices of said plurality of client computing devices.

2. The system according to claim 1, wherein said hyperlink is made visible to only said subset of client computing devices by being stored in a predetermined schema.

3. The system according to claim 1, wherein said hosted content is presented in a format associated with at least one of (a) a blog, (b) a feed, or (c) a podcast.

4. The system according to claim 1, wherein said at least one client computing device of said plurality of client computing devices is one of (a) a closed system gaming console or (b) a general computing device running a closed system environment.

5. The system according to claim 1, wherein said at least one client computing device of said plurality of client computing devices is one of (a) mobile computing device or (b) a stationary computing device.

6. The system according to claim 1, wherein said hyperlink is associated with banner advertisements.

7. The system according to claim 1, wherein said hosted content is controlled by a third party to parties associated with said plurality of client computing devices and said service computing device.

8. The system according to claim 1, wherein said hosted content is publicly available.

9. The system according to claim 1, wherein said subset of client computing devices is set by a party associated with said media computing device.

10. The system according to claim 1, wherein said subset of client computing devices is set by authors of said content.

11. The system according to claim 1, wherein said hyperlink is embedded in at least one of (a) a voice mail, (b) a text mail, (c) a podcast, or (d) a video.

12. The system according to claim 1, further comprising a module allowing at least one user of said plurality of client computing devices to change the appearance of an interface provided by said service computing device.

13. A method for creating, sending, and displaying hyperlinks among a plurality of computing devices, including client and server computing devices, comprising:
selecting a content package to publish to a community of computing device users;
uploading said content package to a server computing device;
storing said content package on said server computing device, wherein said content package is publicly available to said community of device users;
creating a first hyperlink as part of said content package, wherein a hyperlinked content is accessible via said first hyperlink by a community of computing devices;
wherein said first hyperlink is visible to a limited group of computing devices in said community of computing devices;
sending in a first message from a first computing device of said community of computing devices to another at least one computing device of said community of computing devices, wherein said first message has embedded said first hyperlink; and
receiving in a second message from an administrator of said community computing devices a second hyperlink linked to a second hyperlinked content.

14. The method according to claim 13, further comprising receiving in a third message from at least one computing device of said community of computing devices a third hyperlink to publicly available content that is visible only to said limited group of computing devices.

15. The method according to claim 13, wherein said first message is at least one of (a) a voice mail, (b) a text mail, (c) a podcast, or (d) a video.

16. The method according to claim 13, wherein said first hyperlink is visible to said limited group of computing devices by being associated with a predetermined schema.

17. A computer readable medium storing thereon computer executable instructions for at least allowing a plurality of users to send hyperlinks to a community of gaming computing device users and for allowing administrators to send and display hyperlinks to said community of gaming computing device users, comprising:
at least one instruction that receives content from a closed computing device from a set of computing devices, including other closed computing devices and general purpose computing devices, wherein said content is a hosted content on a service computing device;
at least one instruction that stores said hosted content on said service computing device, wherein said service computing device is configured to interact with said set of computing devices as a server computing device or a peer computing device;
at least one instruction that publishes said hosted content to said set of computing devices according to a predetermined schema, resulting in said any hyperlinks associated with said hosted content to be visible only to said closed computing devices and being invisible to said general purpose computing devices; and
at least one instruction that receives and forwards a message with an embedded hyperlink of said hyperlinks to at least one of closed computing device.

18. The computer readable medium according to claim 17, further comprising at least one instruction that makes said hyperlinks visible to said general purpose computing device when said general purpose computing device is running a closed computing system environment that is configured to communicate with said server.

19. The computer readable medium according to claim 17, wherein said hosted content is publicly available.

20. The computer readable medium according to claim 17, wherein said hyperlinks are embedded in at least one of (a) a voice mail, (b) a text mail, (c) a podcast, or (d) a video.
